(19) United States
(12) Patent Application Publication
(10) Pub. No.: US 2015/0371766 A1
(43) Pub. Date: Dec. 24, 2015

(54) COIL COMPONENT AND METHOD OF PRODUCING THE SAME

(71) Applicant: TDK Corporation, Tokyo (JP)

(72) Inventors: Yoshihiro KAWASAKI, Tokyo (JP); Nobuo TAKAGI, Tokyo (JP); Kouyu OHI, Yamagata (JP); Hiroyuki ABE, Yamagata (JP)

(73) Assignee: TDK Corporation, Tokyo (JP)

(21) Appl. No.: 14/744,273

(22) Filed: Jun. 19, 2015

(30) Foreign Application Priority Data
Jun. 19, 2014 (JP) 2014-126538

(51) Int. Cl. H01F 27/29; H01F 27/24; H01F 41/06; H01F 27/28

(52) U.S. Cl. CPC H01F 27/29; H01F 27/2823; H01F 27/24; H01F 41/0666

(57) ABSTRACT

A coil component is provided with first wire and second wires that are wound around a winding core. n^{th} turns of the first and second wires are wound around a surface of the winding core in this order in parallel and form a first winding layer. Each of n+1^{th} and subsequent turns of the second wire is wound around the surface of the winding core so as to be parallel to a previous turn of the second wire and form the first winding layer. Each of n+1^{th} and subsequent turns of the first wire is wound on the first winding layer so as to be fitted into a valley of the first winding layer formed by the same and previous turns of the second wire and form a second winding layer. The same turns of the first and second wires are adjacent to each other at each turn.

### BACKGROUND OF THE INVENTION

1. Field of the Invention

The present invention relates to a coil component and a method of producing the coil component, and particularly to a coil component that includes a winding structure in which two wires are wound around a winding core, as well as a method of producing the coil component.

2. Description of Related Art

Coil components, such as transformers, common mode filters, and baluns, have a pair of coils that are magnetically coupled to each other. In the case of a wire-wound coil component, two wires are wound around a magnetic core in order to form a pair of coils.

As one type of the winding structure of the wire-wound coil component, a two-layer winding structure has been known. In a typical two-layer winding structure, at first one wire is wound around as a first layer. Then, on the first layer of the winding, a second-layer wire is wound. However, in the case of the typical two-layer winding structure, the second layer is wound around after the winding of the first layer is completed. The problem is that winding-work time (takt time), or the time required to completely wind the two wires, becomes long.

To solve the problem, Japanese Patent No. 4,148,115 discloses a method of: winding a first wire and a second wire in parallel at the position of a first layer; forming a second layer by moving the first wire that is in contact with a portion that is wound around a winding core up to an intermediate point between the first and second wires that are wound in parallel in the first layer; and winding the first and second wires at almost the same time by moving the first wire that constitutes the second layer up to an intermediate point of the second wire of the first layer that has been wound around the winding core while winding the second wire that constitutes the first layer on the winding core. According to this method, the parallel two-layer winding can be carried out at the same time while the formation of the first layer precedes. Therefore, it is possible to almost halve the winding work time compared with the conventional method.

However, in the case of the conventional coil component disclosed in Japanese Patent No. 4,148,115, the first wire and the second wire are not adjacent to each other at the same turn, and the distance between the wires is long. Therefore, the problem is that the magnetic coupling is low between the wires at the same turn. Moreover, since the distance between the wires at the same turn is long, it is difficult to accurately wind the wires at the same turn at the same time. Therefore, another problem is that a collapse of the winding or an irregular winding is likely to occur.

### SUMMARY

The object of the present invention is to provide a coil component that is excellent in the magnetic coupling between a pair of wires at the same turn and which is unlikely to face a collapse of the winding or an irregular winding, and a method of producing the coil component.

To solve the above problems, a coil component of the present invention includes: a winding core; and a first wire and a second wire that are wound around the winding core, wherein a n^{th} turn of the first wire and a n^{th} turn of the second wire are wound around a surface of the winding core in this order in parallel and form a first winding layer, each of n+1^{th} and subsequent turns of the second wire except for at least a final turn is wound around the surface of the winding core so as to be parallel to a previous turn of the second wire and form the first winding layer together with the n^{th} turn of the first wire and the n^{th} turn of the second wire, each of n+1^{th} and subsequent turns of the first wire except for at least a final turn is wound on the first winding layer so as to be fitted into a valley of the first winding layer formed by the same and previous turns of the second wire and form a second winding layer, and the same turns of the first and second wires are adjacent to each other at each turn.

According to the present invention, the distance between the same turns of the first and second wires is always the shortest distance at each turn. Therefore, it is possible to increase the magnetic coupling between the first and second wires and to improve the performance of the coil component. Moreover, the same turns of the pair of wires are adjacent to each other. Therefore, it is possible to easily carry out highly-accurate winding work. As a result, it is possible to provide the coil component that is unlikely to face a collapse of the winding of the pair of wires or an irregular winding.

In the present invention, at least the first turns of the first and second wires are preferably wound in this order in parallel in a single layer from the one end of the winding core to the other end to form the first winding layer. In this case, n may be equal to 1, or n may be greater than or equal to 2. When n=1, only the first turns of the first and second wires are wound in parallel in a single layer to form the first winding layer. When n≧2, a plurality of turns of the first and second wires are wound in parallel in a single layer to form the first winding layer. In both cases, it is possible to provide the coil component that is unlikely to face a collapse of the winding or an irregular winding at the beginning of the winding.

In the present invention, at least the final turns of the first and second wires are preferably wound in this order in parallel in a single layer from one end of the winding core to the other end and form the first winding layer. In this case, only the final turns may be wound in parallel in a single layer to form the first winding layer; or a plurality of turns, including the final turns, may be wound in parallel in a single layer to form the first winding layer. In both cases, it is possible to provide the coil component that is unlikely to face a collapse of the winding or an irregular winding at the end of the winding.

According to the present invention, a method of producing a coil component in which a first wire and a second wire are wound around a winding core includes: winding a n^{th} turn of the first wire and a n^{th} turn of the second wire around a surface of the winding core in parallel and forming a first winding layer; winding each of n+1^{th} and subsequent turns of the second wire except for at least a final turn on the surface of the winding core so as to be parallel to a previous turn of the second wire and forming the first winding layer together with the n^{th} turn of the first wire and the n^{th} turn of the second wire; and winding each of n+1^{th} and subsequent turns of the first wire except for at least a final turn on the first winding layer so as to be fitted into a valley of the first winding layer formed by the same and previous turns of the second wire and forming a second winding layer. According to the present invention, it is possible to efficiently produce the high-performance coil component by using a well-known spindle winding machine.

According to the present invention, it is possible to provide a coil component that is excellent in the magnetic coupling between a pair of wires at the same turn and which is unlikely to face a collapse of the winding or an irregular winding, and a method of producing the coil component.

### BRIEF DESCRIPTION OF THE DRAWINGS

Preferred embodiments of the present invention will be described in detail below with reference to the accompanying drawings:

FIG. 1 is a perspective view of the appearance of a coil component 1 according to a preferred embodiment of the present invention;

FIG. 2 is a cross-sectional view of the winding structure of the coil component 1;

FIGS. 3A to 3D are schematic diagrams for explaining steps of winding the first wire W₁ and the second wire W₂, and specifically plan views of the coil component 1 when viewed from an upper surface's side;

FIGS. 4A to 4D are schematic diagrams for explaining steps of winding the first wire W₁ and the second wire W₂, and specifically plan views of the coil component 1 when viewed from an upper surface's side;

FIGS. 5A and 5B are schematic diagrams for explaining steps of winding the first wire W₁ and the second wire W₂, and specifically side views of the coil component 1 that is in the situation of FIG. 3C; and

FIGS. 6A and 6B are schematic diagrams for explaining steps of winding the first wire W₁ and the second wire W₂, and specifically side views of the coil component 1 that is in the situation of FIG. 3D; and

FIGS. 6A to 6C are schematic diagrams for explaining steps of winding the first wire W₁ and the second wire W₂, wherein FIGS. 6A and 6B are side views of the coil component 1 that is in the situation of FIG. 3D, and FIG. 6C is a side view of the coil component 1 when the coil component 1 shown in FIG. 3D is further rotated 90 degrees.

### DETAILED DESCRIPTION OF THE EMBODIMENTS

Preferred embodiment of the present invention will be described hereinafter in detail with reference to the accompanying drawings.

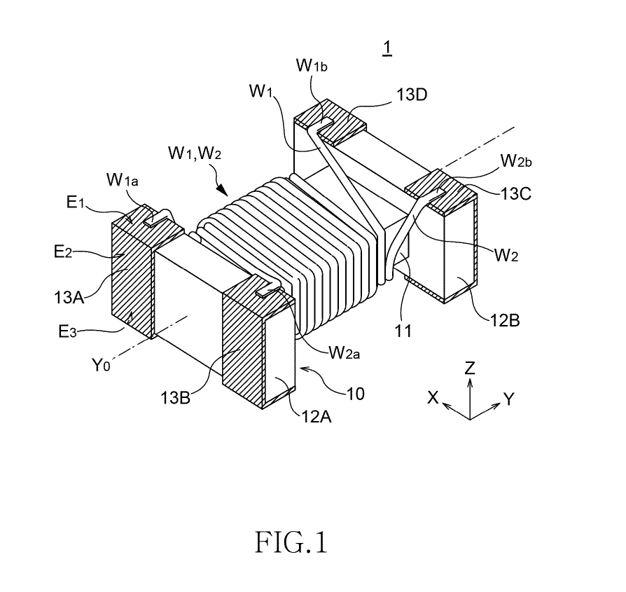

FIG. 1 is a perspective view of the appearance of a coil component 1 according to a preferred embodiment of the present invention.

As shown in FIG. 1, the coil component 1 includes a drum core 10, which is made from magnetic material; and a first wire W₁ and a second wire W₂, which are wound around the drum core 10.

The drum core 10 includes a rod-shaped winding core 11 and flanges 12A and 12B, which are provided at both ends of the winding core 11. The winding core 11 and the flanges 12A and 12B are integrally formed. The first wire W₁ and the second wire W₂ are wound around the winding core 11 of the drum core 10.

On one flange 12A of the drum core 10, a pair of terminal electrodes 13A and 13B is provided. On the other flange 12B, a pair of terminal electrodes 13C and 13D is provided. Among the pair of terminal electrodes 13A and 13B provided on the flange 12A, the terminal electrode 13A is disposed on the one end's side (left side) of the flange 12A in a width direction (X-direction); the terminal electrode 13B is disposed on the other end's side (right side) of the flange 12A in the width direction (X-direction). Among the pair of terminal electrodes 13C and 13D provided on the flange 12B, the terminal electrode 13D is disposed on the one end's side (left side) of the flange 12B in the width direction (X-direction); the terminal electrode 13C is disposed on the other end's side (right side) of the flange 12B in the width direction (X-direction).

The terminal electrodes 13A, 13B, 13C, and 13D all have a three-side electrode structure: the electrodes are continuously formed so as to cover the upper surface, outer side surface, and bottom surface of the flange 12A or 12B. Each terminal electrode includes an upper surface electrode portion E1, which is formed on the upper surface of the flange; a side surface electrode portion E2, which is formed on the outer side surface of the flange; and a bottom surface electrode portion E3, which is formed on the bottom surface of the flange. Incidentally, the outer side surface of the flange is on the opposite side of the flange from an inner side surface that is connected to an end of the winding core 11.

The shape of the drum core 10 including the terminal electrodes 13A to 13D is dyad symmetrical: the shape of the drum core 10 matches the original shape even after the drum core 10 is rotated through 180 degrees about an axis (Z-axis) that is perpendicular to a mounting surface (XY plane). The shape of the drum core 10 is also line symmetrical, with a central axis Y0 of the winding core 11 as the axis of symmetry. The terminal electrode 13A on the flange 12A is in a diagonal relationship with the terminal electrode 13C on the flange 12B. The terminal electrode 13B on the flange 12A is in a diagonal relationship with the terminal electrode 13D on the flange 12B.

The first wire W₁ and the second wire W₂ are coated conductive wires, and form a pair of coils that are magnetically coupled to each other. Both the first wire W₁ and the second wire W₂ are wound counterclockwise from the flange 12A's side to the flange 12B's side. The number of turns of the first wire W₁ is substantially equal to the number of turns of the second wire W². The first wire W₁ and the second wire W₂ are tightly wound around the winding core 11 and form a two-layer winding structure.

Ends of the first and second wires W₁ and W₂ are connected to the corresponding terminal electrodes. More specifically, one end W₁ₐ of the first wire W₁ is connected to the upper surface electrode portion E1 of the terminal electrode 13A of the flange 12A. One end W₂ₐ of the second wire W₂ is connected to the upper surface electrode portion E1 of the terminal electrode 13B of the flange 12A. The other end W_{1b}, of the first wire W₁ is connected to the upper surface electrode portion E1 of the terminal electrode 13D of the flange 12B. The other end W_{2b} of the second wire W₂ is connected to the upper surface electrode portion E1 of the terminal electrode 13C of the flange 12B. As the method of connecting the wires, thereto-compression bonding is preferred. However, other methods may be employed.

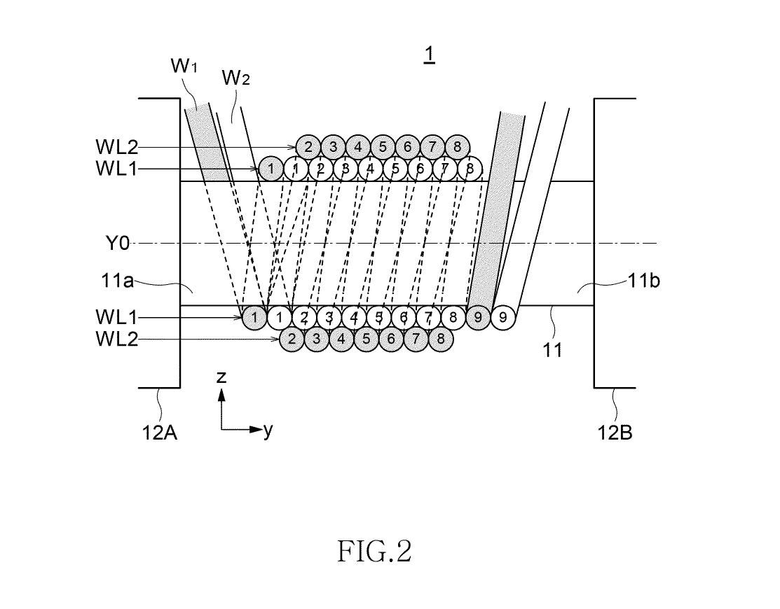

FIG. 2 is a cross-sectional view of the winding structure of the coil component 1.

As shown in FIG. 2, the first wire W₁ and the second wire W₂ are wound counterclockwise from one end 11a of the winding core 11 to the other end 11b and two layers of windings are formed. In particular, the second wire W₂ is wound directly around the surface of the winding core 11 in order to mainly form a first winding layer WL1. The first wire W₁ is wound around on the first winding layer WL1 in order to mainly form a second winding layer WL2. In FIG. 2, the numbers surrounded by circles, which represent the cross-section of the wire, show at which turn the wire is in that location. According to the present embodiment, the number of turns is 9 for the first wire W₁ and the second wire W₂. However, in the case of the present invention, the number of turns is not specifically limited, and may be any value.

As described above, the one end W₁ₐ of the first wire W₁ and the one end W₂ₐ of the second wire W₂ are connected to the terminal electrodes 13A and 13B of the flange 12A, respectively. Then, the first and second wires W₁ and W₂ are wound around the winding core 11. The first turns of the first wire W₁ and second wire W₂ are wound around the surface of the winding core 11 in this order in parallel. As a result, the first winding layer WL1 is formed.

The second turn of the second wire W₂ is wound around the surface of the winding core 11 so as to be in contact with the first turn of the second wire W₂ and be parallel to this first turn. The second turn of the second wire W₂ forms the first winding layer WL1, together with the first turns of the first wire W₁ and second wire W₂.

The second turn of the first wire W₁ is wound around on the first winding layer WL1 so as to be fitted into a valley of the first winding layer WL1 formed by the second and first turns of the second wire W₂. In this manner, the second turn of the first wire W₁ forms the second winding layer WL2.

The third to eighth turns of the second wire W2 are each wound around the surface of the winding core 11 in the same way as the second turn, so as to be in contact with the previous turn and be parallel to this previous turn. In this manner, the third to eighth turns of the second wire W₂ form the first winding layer WL1. The third to eighth turns of the first wire W₁ are each wound around on the first winding layer WL1 in the same way as the second turn, so as to be fitted into a valley of the first winding layer WL1 formed by the same and previous turns of the second wire W₂. In this manner, the third to eighth turns of the first wire W₁ form the second winding layer WL2; each turn is wound parallel to the previous turn of the first wire W₁.

The final, or ninth, turns of the first wire W₁ and second wire W₂ are wound around the surface of the winding core 11 in parallel in this order. The ninth turns of the first wire W₁ and second wire W₂ form the first winding layer WL1, together with the first turns of the first wire W₁ and second wire W₂ and the second to eighth turns of the second wire W₂. That is, at the final turn, the structure returns to the single-layer structure from the two-layer structure. After that, the other end W_{1b}, of the first wire W₁ and the other end W_{2b} of the second wire W₂ are connected to the terminal electrodes 13D and 13C of the flange 12B, respectively.

In the coil component 1 with the above-described winding structure, the same turns of the first wire W₁ and second wire W₂ are adjacent to each other at each turn. Therefore, it is possible to increase the magnetic coupling between the coil formed by the first wire W₁ and the coil formed by the second wire W₂, resulting in increase in the performance of the coil component 1. Moreover, since the same turns are adjacent to each other, it is possible to accurately and easily carry out the winding work and thereby to prevent a collapse of the windings of the wires or an irregular winding.

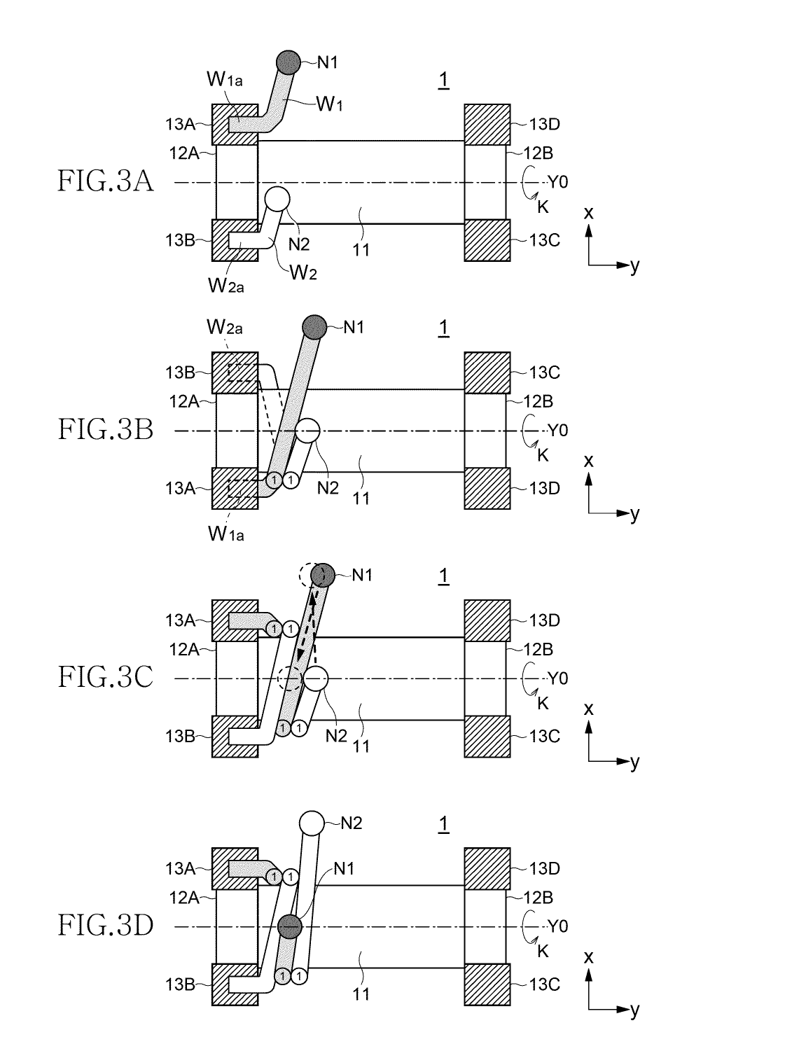

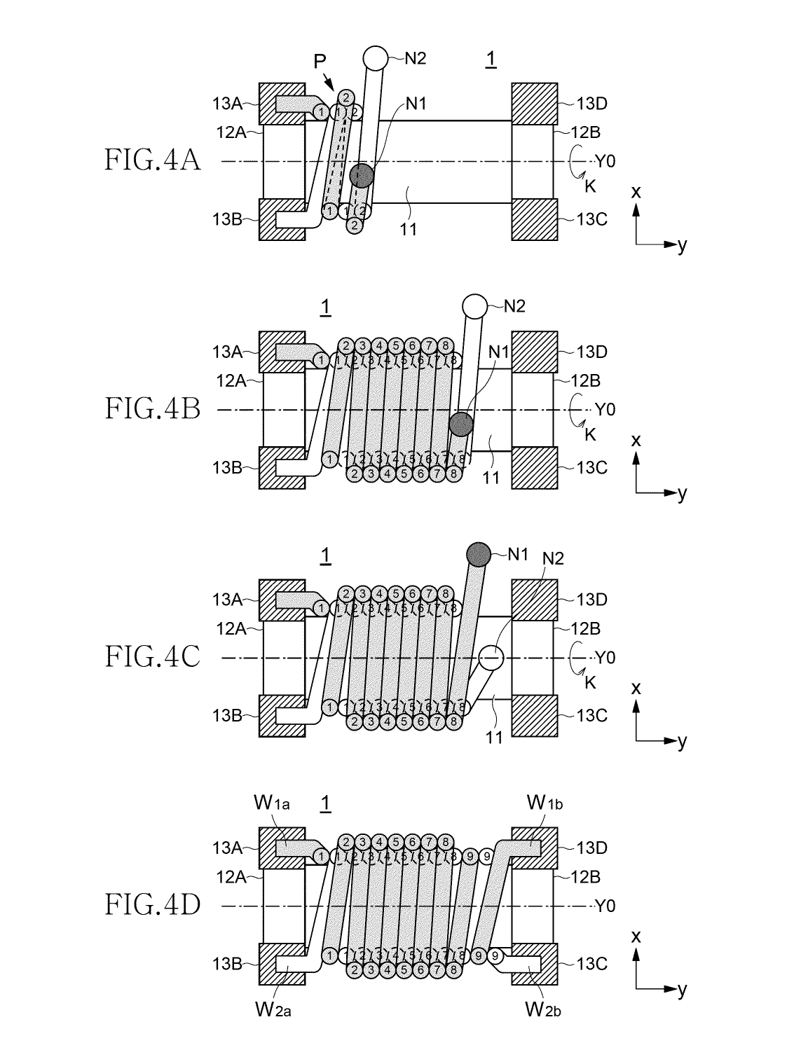

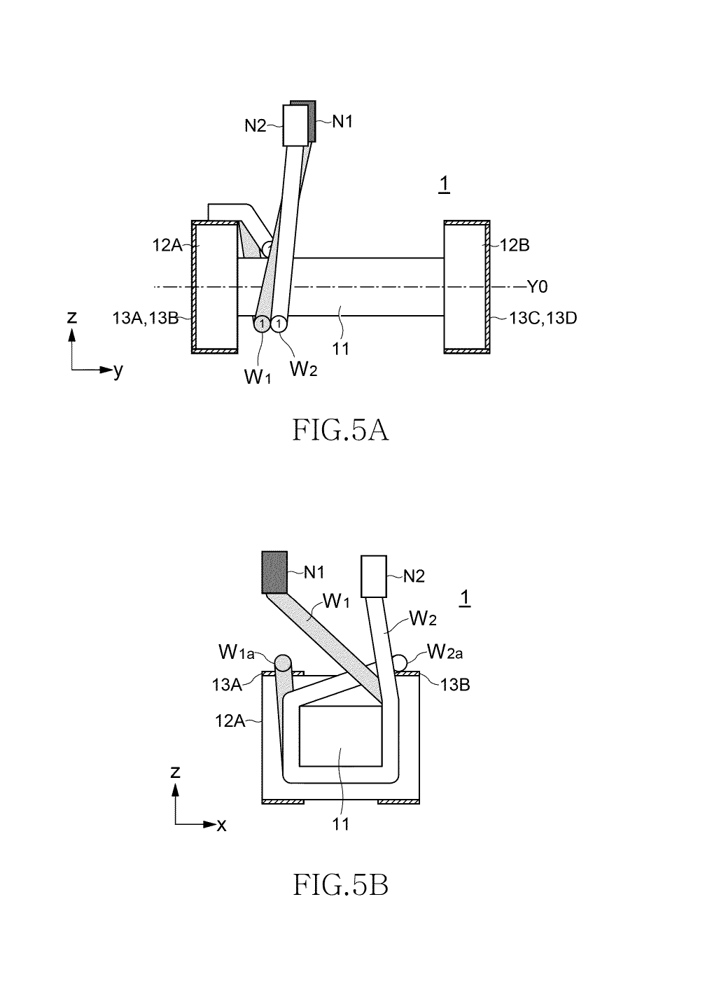

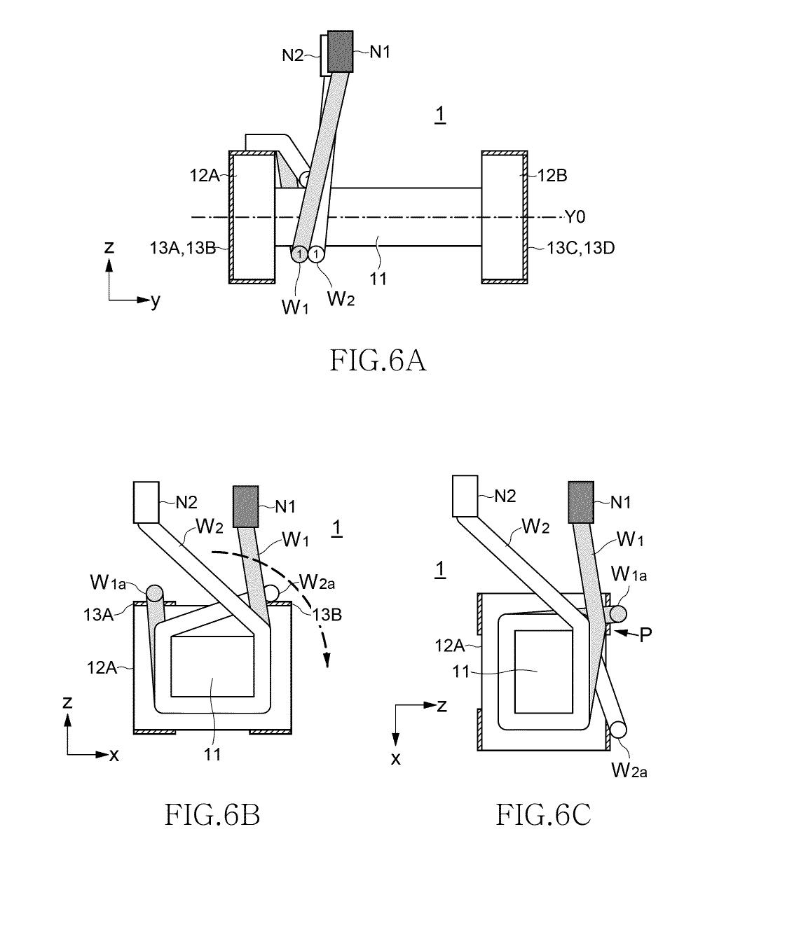

FIGS. 3 to 6 are schematic diagrams for explaining steps of winding the first wire W₁ and the second wire W₂. Particularly, FIGS. 3A to 3D and FIGS. 4A to 4D are plan views of the coil component 1 when viewed from an upper surface's side. FIGS. 5A and 5B are side views of the coil component 1 that is in the situation of FIG. 3C. FIGS. 6A and 6B are side views of the coil component 1 that is in the situation of FIG. 3D. FIG. 6C is a side view of the coil component 1 when the coil component 1 shown in FIG. 3D is further rotated 90 degrees.

During the winding process, at first the drum core 10 is set in a well-known spindle winding machine (not shown). Then, as shown in FIG. 3A, the first wire W₁ and the second wire W₂ are supplied from a pair of wire supply nozzles N₁ and N₂ of the spindle winding machine; the one end W₁ₐ of the first wire W₁ and the one end W₂ₐ of the second wire W₂ are connected to the terminal electrodes 13A and 13B, respectively.

After that, the first wire W₁ and the second wire W₂ are fed from the pair of wire supply nozzles N₁ and N₂, while the drum core 10, which is supported by the spindle winding machine in a rotatable manner, is rotated around the central axis Y0 of the winding core 11. In conjunction with the rotation of the drum core 10, the positions of the first and second wire supply nozzles N₁ and N₂ are moved in a direction from the one end 11a of the winding core 11 to the other end 11b. In this manner, the first wire W₁ and the second wire W₂ are wound around the winding core 11.

As shown in FIGS. 3B and 3C, the first turns of the first wire W₁ and second wire W₂ are wound so as to be close to the one end 11a of the winding core 11. From the situation shown in FIG. 3A, the drum core 10 is rotated 180 degrees in K-direction indicated by arrow (or counterclockwise). As a result, as shown in FIG. 3B, about half the turn of the first wire W₁ and that of the second wire W₂ are wound around the surface of the winding core 11 in this order in parallel. The drum core 10 is then rotated another 180 degrees. As a result, as shown in FIG. 3C, the remaining about another half turn of the first wire W₁ and that of the second wire W₂ are wound around the surface of the winding core 11 in this order in parallel.

At this time, as shown in FIGS. 3C, 5A, and 5B, the position of the first wire supply nozzle N₁ that supplies the first wire W₁ is placed at a preceding position that precedes the position of the second wire supply nozzle N₂ that supplies the second wire W₂. Therefore, the winding of the first wire W₁ can precede the winding of the second wire W₂ within the range of the same turn. Incidentally, the preceding position of the wire supply nozzle is a position where the wire can be wound prior to the other. In X-direction, which is perpendicular to the central axis Y0, the preceding position is a front side of the wire in the winding direction.

Then, as shown in FIGS. 3D, 6A, and 6B, before the second turns of the first wire W₁ and second wire W₂ are wound, the positions of the first wire supply nozzle N₁ and second wire supply nozzle N₂ are interchanged. That is, the position of the second wire supply nozzle N₂ is moved to a preceding position that precedes the position of the first wire supply nozzle N₁.

After that, the drum core 10 is rotated 90 degrees. Accordingly, as shown in FIG. 6C, the second turn of the second wire W₂ is wound so as to be in contact with the first turn of the second wire W₂. The second turn of the first wire W₁ is wound so as to be moved onto the first winding layer WL1 while being fitted into a valley of the first winding layer WL1 formed by the second and first turns of the second wire W₂. Point P in FIG. 6C represents the position where the second turn of the first wire W₁ is moved up.

The drum core 10 is further rotated. Then, as shown in FIG. 4A, the second turn of the second wire W₂ is wound so as to be in contact with the first turn of the second wire W₂, and becomes part of the first winding layer WL1. The second turn of the first wire W₂ is wound around on the first winding layer WL1 so as to be fitted into a valley of the first winding layer WL1 formed by the second and first turns of the second wire W₂, and becomes part of the second winding layer WL2.

Then, as shown in FIG. 4B, the third to eighth turns of the first wire W₁ and second wire W₂ are wound. In order to wind the third and eighth turns, the first and second wire supply nozzles N₁ and N₂ remain in the positional relationship set at the second turns when being moved to the positive side of the Y-axis direction.

Then, as shown in FIG. 4C, before the ninth turns (final turns) of the first wire W₁ and second wire W₂ are wound, the positional relationship between the first wire supply nozzle N₁ and the second wire supply nozzle N₂ returns to the original relationship. That is, the X-direction position of the first wire supply nozzle N₁ is moved to the front side of the winding direction, and the X-direction position of the second wire supply nozzle N₂ is moved to the rear side of the winding direction. Therefore, as shown in the diagrams, the position of the first wire supply nozzle N₁ is placed again at a preceding position that precedes the position of the second wire supply nozzle N₂. After that, the drum core 10 is rotated 360 degrees in order to wind the ninth turns of the first wire W₁ and second wire W₂.

Finally, as shown in FIG. 4D, the other end W_{1b} of the first wire W₁ and the other end W_{2b} of the second wire W₂ are connected to the terminal electrodes 13D and 13C, respectively. In this manner, the winding process of the first wire W₁ and second wire W₂ is completed.

As described above, according to the production method of the coil component 1 of the present embodiment, the first turns of the first wire W₁ and second wire W₂ are wound around the surface of the winding core 11 in this order in parallel in order to form the first winding layer; the second turn of the second wire W₂ is wound so as to precede the second turn of the first wire W₁ and be in contact with the first turn of the second wire W₂ in order to further form the first winding layer; the second turn of the first wire W₁ is wound so as to be placed in a valley of the first winding layer formed by the second and first turns of the second wire W₂ in order to form the second winding layer; and the third and subsequent turns of the second wire W₂ are formed in the first layer, and the third and subsequent turns of the first wire W₁ are formed in the second layer. Therefore, the first wire W₁ and the second wire W₂ can be almost simultaneously wound by the spindle winding machine. Thus, it is possible to efficiently produce the high-quality and high-performance coil component 1 that is unlikely to face a collapse of winding or an irregular winding.

Although the preferable embodiment of the invention has been described above, it is needless to say that the invention is by no means restricted to the embodiment and can be embodied in various modes within the scope which does not depart from the gist of the invention.

For example, in the case of the above embodiment, only the first turns of the first wire W₁ and second wire W₂ are wound in a single layer, and the second and subsequent turns are wound in two layers except for the final turns. However, for example, the first and second turns may be wound in a single layer, and the third and subsequent turns may be wound in two layers except for the final turns. That is, at least the n^{th} turns (n is positive number greater than or equal to 1) of the first wire W₁ and second wire W₂ may be wound in a single layer, and the n+1^{th} and subsequent turns may be wound in two layers.

In the case of the above embodiment, the first wire W₁ and the second wire W₂ are wound in two layers until the number of turns reaches 8, and only the final, or ninth, turns are wound in a single layer. However, for example, the first wire W₁ and the second wire W₂ may be wound in two layers until the number of turns reaches 7, and the eighth and ninth turns maybe wound in a single layer. That is, all that is required is for at least the final turns of the first wire W₁ and second wire W₂ to be wound in a single layer.

In the case of the above embodiment, the first wire W₁ and second wire W₂ that constitute a pair of coils are wound around the drum core 10. However, according to the present invention, the drum core 10 is not necessarily required to be used. All that is required is for the first wire W₁ and the second wire W₂ to be simply wound around a winding core. Moreover, the three-side-electrode-structure terminal electrodes are used. However, the configuration of the terminal electrodes is not specifically limited. Furthermore, according to the above embodiment, the ends of the wires are connected to the upper surface electrode portions E1 of the terminal electrodes 13A to 13D. Instead, the ends of the wires may be connected to the bottom surface electrode portions E3 or the side surface electrode portions E2. Furthermore, the core, which is part of the coil component, may be made by combining the drum core 10 and a plate-like core.

What is claimed is:

1. A coil component comprising:
a winding core; and
a first wire and a second wire that are wound around the winding core, wherein
a n^{th} turn of the first wire and a n^{th} turn of the second wire are wound around a surface of the winding core in this order in parallel and form a first winding layer,
each of n+1^{th} and subsequent turns of the second wire except for at least a final turn is wound around the surface of the winding core so as to be parallel to a previous turn of the second wire and form the first winding layer together with the n^{th} turn of the first wire and the n^{th} turn of the second wire,
each of n+1^{th} and subsequent turns of the first wire except for at least a final turn is wound on the first winding layer so as to be fitted into a valley of the first winding layer formed by the same and previous turns of the second wire and form a second winding layer, and
the same turns of the first and second wires are adjacent to each other at each turn.

2. The coil component as claimed in claim 1, wherein at least the final turns of the first and second wires are wound in this order in parallel in a single layer from one end of the winding core to the other end and the first winding layer.

3. The coil component as claimed in claim 1 further comprising a drum core including the winding core and first and second flanges provided at both ends of the winding core.

4. The coil component as claimed in claim 3 further comprising:
first and second terminal electrodes provided on the first flange; and
third and fourth terminal electrodes provided on the second flange, wherein
one end of the first wire is connected to the first terminal electrode,
one end of the second wire is connected to the second terminal electrode,
the other end of the first wire is connected to the third terminal electrode, and
the other end of the second wire is connected to the fourth terminal electrode.

5. A method of producing a coil component in which a first wire and a second wire are wound around a winding core, the method comprising:
winding a n^{th} turn of the first wire and a n^{th} turn of the second wire around a surface of the winding core in parallel and forming a first winding layer;
winding each of n+1^{th} and subsequent turns of the second wire except for at least a final turn on the surface of the winding core so as to be parallel to a previous turn of the second wire and forming the first winding layer together with the n^{th} turn of the first wire and the n^{th} turn of the second wire; and
winding each of n+1^{th} and subsequent turns of the first wire except for at least a final turn on the first winding layer so as to be fitted into a valley of the first winding layer formed by the same and previous turns of the second wire and forming a second winding layer.

6. The method of producing a coil component as claimed in claim 5 further comprising
winding at least the final turns of the first and second wires around the surface of the winding core in this order in parallel and forming the first winding layer.

7. The method of producing a coil component as claimed in claim 5, wherein the n=1.

8. The method of producing a coil component as claimed in claim 5, wherein the coil component has a drum core including the winding core and first and second flanges provided at both ends of the winding core.

9. The method of producing a coil component as claimed in claim 8, wherein
the coil component has first to fourth terminal electrodes,
the first and second terminal electrodes are provided on the first flange, and
the third and fourth terminal electrodes are provided on the second flange.

10. The method of producing a coil component as claimed in claim 9 further comprising
connecting the one end of the first wire and the one end of the second wire to the first and second terminal electrodes, respectively, before winding a first turn of the first wire and a first turn of the second wire around the surface of the winding core in parallel and forming the first winding layer.

11. The method of producing a coil component as claimed in claim 10 further comprising
connecting the other end of the first wire and the other end of the second wire to the third and fourth terminal electrodes, respectively, after winding the final turn of the first wire and the final turn of the second wire around the surface of the winding core in parallel and forming the first winding layer.

12. The method of producing a coil component as claimed in claim 5, wherein the first and second wires are wound by using a spindle winding machine.

13. A coil component comprising:
a drum core including:
a winding core having first and second ends;
a first flange provided at the first end of the winding core;
a second flange provided at the second end of the winding core;
first and second terminal electrodes provided on the first flange; and
third and fourth terminal electrodes provided on the second flange;
a first wire wound around the winding core, the first wire having one end connected to the first terminal electrode and the other end connected to the third terminal electrode and;
a second wire wound around the winding core, the second wire having one end connected to the second terminal electrode and the other end connected to the fourth terminal electrode,
wherein a n^{th} turn of the first wire, a n^{th} turn of the second wire, a n+1^{th} turn of the second wire, and a n+2^{th} turn of the second wire are wound around the winding core in this order from the first end to the second end,
wherein a n+1^{th} turn of the first wire is wound along a valley formed by the n^{th} and n+1^{th} turns of the second wire, and
wherein a n+2^{th} turn of the first wire is wound along a valley formed by the n+1^{th} and n+2^{th} turns of the second wire.

14. The coil component as claimed in claim 13,
wherein a m^{th} turn of the second wire, a m+1^{th} turn of the second wire, a m+2^{th} turn of the first wire, and a m+2^{th} turn of the second wire are wound around the winding core in this order from the first end to the second end, and
wherein a m+1^{th} turn of the first wire is wound along a valley formed by the m^{th} and m+1^{th} turns of the second wire.

15. The coil component as claimed in claim 13, wherein the n^{th} turn is a first turn counting from the first flange.

16. The coil component as claimed in claim 14, wherein the m+2^{th} turn is a first turn counting from the second flange.

17. The coil component as claimed in claim 14, wherein the n+1^{th} to m+1^{th} turns of the first wire are formed on the second wire.
